(19) United States
(12) Patent Application Publication
(10) Pub. No.: US 2018/0279575 A1
(43) Pub. Date: Oct. 4, 2018

(54) SIDE OF PET CAGE

(71) Applicant: Hongkun LIANG, Zhong Shan City (CN)

(72) Inventor: Hongkun LIANG, Zhong Shan City (CN)

(21) Appl. No.: 15/602,589

(22) Filed: May 23, 2017

(30) Foreign Application Priority Data
Apr. 1, 2017 (CN) 201720346607.4

(51) Int. Cl. A01K 1/00; F16B 5/00; F16B 45/00

(52) U.S. Cl. CPC A01K 1/0035; F16B 45/00; A01K 1/0064; F16B 5/0084

(57) ABSTRACT

A side of a pet cage, including a frame enclosed by a metal bar, where the frame is connected to multiple mutually interlaced horizontal bars and vertical bars, and the frame is further provided with a hook portion that is formed integrally with the frame in a bending manner. The present utility model has a simple structure, low costs, and high production efficiency.

### BACKGROUND

### Technical Field

The present utility model relates to a pet cage, and more specifically, to a side of a pet cage.

### Related Art

As shown in FIG. 1 and FIG. 2, in a structure of a conventional pet cage, metal bars are welded into grids, and then, the grids are assembled to form a cubic pet cage, and the grids are sides of the pet cage. Some grids are welded with hook portions, and when the pet cage is assembled, the grid may hook an adjacent grid thereof by means of a hook portion, so as to increase firmness of the pet cage. In addition, a hook portion welded to a grid that is used as a door of the pet cage may hook another grid when the door is locked, so as to keep the pet cage firm. However, a pet cage of such a structure still has disadvantages. That is, a hook portion is welded to a grid by using an individual metal bar, resulting in more manufacturing procedures, complex process, and low production efficiency, and a welding process has high requirements on skills of workers and has relatively high human power costs.

Therefore, the present utility model is generated based on the foregoing disadvantages.

### SUMMARY

An objective of the present utility model is to overcome disadvantages in the prior art to provide a side of a pet cage having a simple structure, low costs, and high production efficiency.

The present utility model is implemented by means of the following technical solutions:

A side of a pet cage includes a frame 1 enclosed by a metal bar, where the frame 1 is connected to multiple mutually interlaced horizontal bars 2 and vertical bars 3, and the frame 1 is further provided with a hook portion 4 that is formed integrally with the frame 1 in a bending manner.

The hook portion 4 as stated above is disposed on a side of the frame 1, the hook portion 4 includes two vertical sections 41 that are bent on the frame 1 and that extend upward, each vertical section 41 is bent toward a side thereof to form a horizontal section 42, each horizontal section 42 is bent downward to form a hook section 43, and a connection section 44 is formed between two hook sections 43 to connect the hook sections 43.

There are two hook portions 4 as stated above, and the hook portions 4 are disposed on a same side of the frame 1.

The hook portions 4 as stated above are disposed on two opposite sides of the frame 1, the hook portion 4 includes two horizontal segments 45 that are formed in a bending manner on the frame 1 and that are spaced from each other, each horizontal segment 45 is bent toward another side of the frame 1 to from a vertical segment 46, and a connection segment 47 is formed between two vertical segments 46 to connect the two vertical segments 46.

There are four hook portions 4 as stated above, and the hook portions 4 are pairwise evenly disposed on two opposite sides of the frame 1.

As compared with the prior art, the present utility model has the following advantages. A frame of the present utility model is enclosed by a metal bar, and the frame enclosed by the metal bar is provided with a hook portion that is formed integrally with the frame in a bending manner. Therefore, the hook portion and the frame are formed by bending the same metal bar, which may be completed by automatic processing of a machine. It does not need to cut an individual metal bar to weld a hook portion, so that a structure of a side of a pet cage is simpler, a manufacturing process is simpler, production efficiency is higher, and costs are lowered.

### BRIEF DESCRIPTION OF THE DRAWINGS

FIG. 1 is a three-dimensional diagram of a pet cage in the prior art;

FIG. 2 is a three-dimensional diagram of a side of a pet cage in the prior art;

FIG. 3 is a three-dimensional diagram of Embodiment 1 of the present utility model;

FIG. 4 is a three-dimensional diagram of Embodiment 2 of the present utility model;

FIG. 5 is an enlarged view of a position A in FIG. 3; and

FIG. 6 is an enlarged view of a position B in FIG. 4.

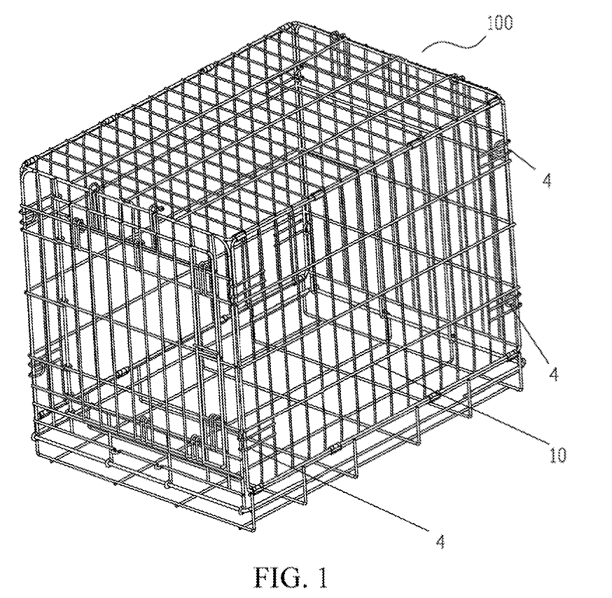

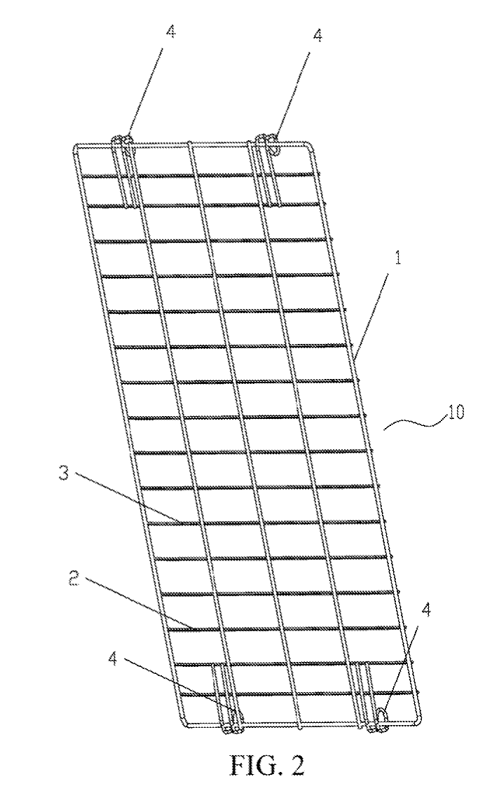

### DETAILED DESCRIPTION

The present utility model is further described below with reference to the accompanying drawings.

### EMBODIMENT 1

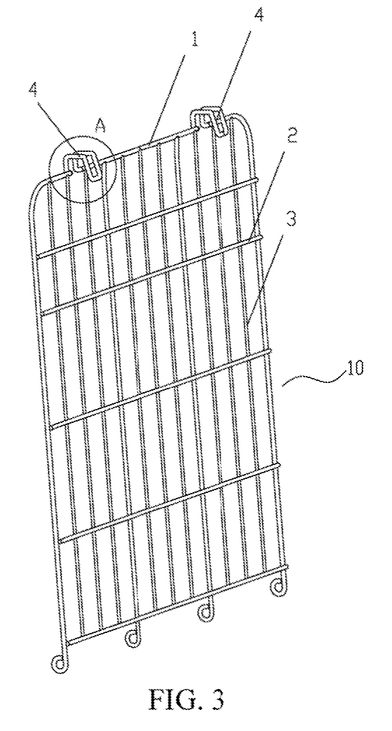

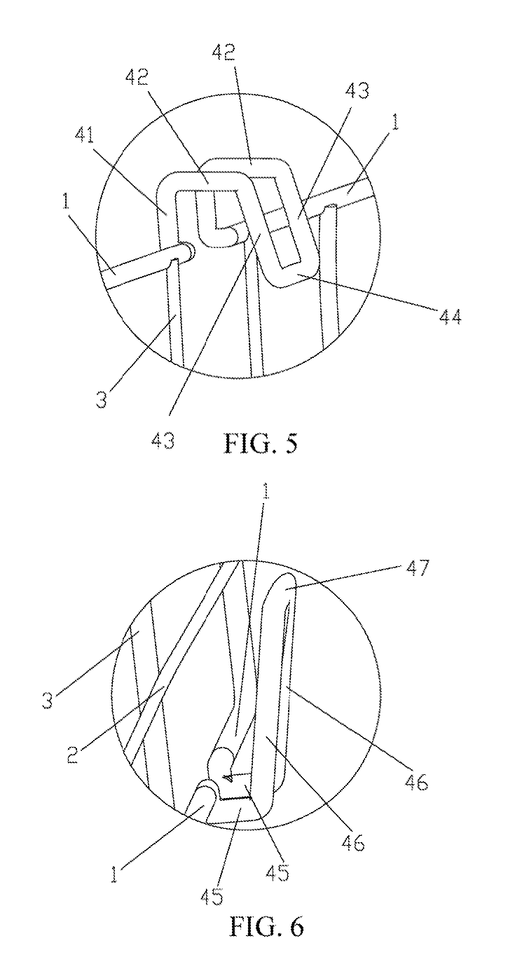

As shown in FIG. 3 and FIG. 5, a side 10 of a pet cage includes a frame 1 enclosed by a metal bar, where the frame 1 is connected to multiple mutually interlaced horizontal bars 2 and vertical bars 3, the horizontal bars 2, the vertical bars 3, and the frame 1 form a grid, and the frame 1 is further provided with a hook portion 4 that is formed integrally with the frame 1 in a bending manner. The frame 1 is enclosed by a metal bar, and the frame 1 enclosed by the metal bar is provided with the hook portion 4 that is formed integrally with the frame in a bending manner. Therefore, the hook portion 4 and the frame 1 are formed by bending the same metal bar, which may be completed by automatic processing of a machine. It does not need to cut an individual metal bar to weld a hook portion, so that a structure of the side 10 of the pet cage is simpler, a manufacturing process is simpler, production efficiency is higher, and costs are lowered.

The hook portion 4 is disposed on a side of the frame 1, the hook portion 4 includes two vertical sections 41 that are bent on the frame 1 and that extend upward, each vertical section 41 is bent toward a side thereof to form a horizontal section 42, each horizontal section 42 is bent downward to form a hook section 43, and a connection section 44 is formed between two hook sections 43 to connect the hook sections 43. There are two hook portions 4, and the hook portions 4 are disposed on a same side of the frame 1. In addition, the side 10 of the pet cage may be used as a door of the pet cage, and when the door of the pet cage is locked, the hook portion 4 is hung to a top cover of the pet cage, to ensure locking and firmness of the door of the pet cage.

EMBODIMENT 2

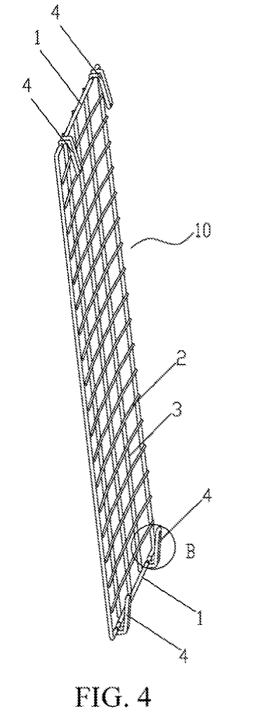

As shown in FIG. 4 and FIG. 6, a side 10 of a pet cage includes a frame 1 enclosed by a metal bar, where the frame 1 is connected to multiple mutually interlaced horizontal bars 2 and vertical bars 3, the horizontal bars 2, the vertical bars 3, and the frame 1 form a grid, and the frame 1 is further provided with a hook portion 4 that is formed integrally with the frame 1 in a bending manner.

The hook portions 4 as stated above are disposed on two opposite sides of the frame 1, the hook portion 4 includes two horizontal segments 45 that are formed in a bending manner on the frame 1 and that are spaced from each other, each horizontal segment 45 is bent toward another side of the frame 1 to from a vertical segment 46, and a connection segment 47 is formed between two vertical segments 46 to connect the two vertical segments 46.

There are four hook portions 4, and the hook portions 4 are pairwise evenly disposed on two opposite sides of the frame 1. Therefore, the hook portions 4 on the side 10 of the pet cage can hook girds adjacent thereto, to ensure firmness of the pet cage formed by assembling the grids.

1. A side of a pet cage, comprising a frame enclosed by a metal bar, wherein the frame is connected to multiple mutually interlaced horizontal bars and vertical bars, and the frame is further provided with a hook portion that is formed integrally with the frame in a bending manner.

2. The side of a pet cage according to claim 1, wherein the hook portion is disposed on a side of the frame, the hook portion comprises two vertical sections that are bent on the frame and that extend upward, each vertical section is bent toward a side thereof to form a horizontal section, each horizontal section is bent downward to form a hook section, and a connection section is formed between two hook sections to connect the hook sections.

3. The side of a pet cage according to claim 2, wherein there are two hook portions, and the two hook portions are disposed on a same side of the frame.

4. The side of a pet cage according to claim 1, wherein the hook portions are disposed on two opposite sides of the frame, the hook portion comprises two horizontal segments that are formed in a bending manner on the frame and that are spaced from each other, each horizontal segment is bent toward another side of the frame to from a vertical segment, and a connection segment is formed between two vertical segments to connect the two vertical segments.

5. The side of a pet cage according to claim 4, wherein there are four hook portions, and the hook portions are pairwise evenly disposed on two opposite sides of the frame.
